(19) United States
(12) Patent Application Publication
(10) Pub. No.: US 2024/0402523 A1
(43) Pub. Date: Dec. 5, 2024

(54) FIBER FARADAY ROTATOR

(71) Applicant: CORNING INCORPORATED, Corning, NY (US)

(72) Inventors: Nicholas Francis Borrelli, Elmira, NY (US); David August Sniezek Loeber, Horseheads, NY (US); Dean Michael Thelen, Addison, NY (US)

(21) Appl. No.: 18/384,116

(22) Filed: Oct. 26, 2023

Related U.S. Application Data
(60) Provisional application No. 63/421,262, filed on Nov. 1, 2022.

(51) Int. Cl. G02F 1/095; G02F 1/01

(52) U.S. Cl. CPC G02F 1/095; G02F 1/0136

(57) ABSTRACT

A Faraday rotator that simultaneously achieves substantial polarization rotation and net zero bend-induced birefringence can be made using optical fiber bent into multiple (e.g., a large number of) fiber turns extending along a common, substantially closed-loop path and surrounded by a solenoid, with the closed-loop path shaped in three dimensions to include loop sections in mutually orthogonal planes.

### CROSS-REFERENCE TO RELATED APPLICATIONS

This application claims the benefit of priority under 35 U.S.C. § 119 of U.S. Provisional Application No. 63/421,262 filed Nov. 1, 2022, the content of which is incorporated herein by reference in its entirety.

### TECHNICAL FIELD

This disclosure pertains to optical polarization rotators and controllers utilizing the Faraday effect, e.g., for use in quantum communication systems.

### BACKGROUND

Polarization control in optical communication systems has been a topic of research for decades due to polarization fluctuations occurring in standard optical fiber. Any change in the temperature or stress in the optical fiber can potentially result in a change in polarization. For optical links on the order of kilometers in length, significant change in polarization can occur on timescales as short as a millisecond. Classical communication systems used in the field have largely been able to achieve polarization control through the use of clever optics combined with signal processing, and avoided the need for polarization controllers. In quantum communication links, however, these solutions are not so readily available due to low (often single-photon) signal levels and frequent use of polarization encoding. Thus, quantum communication systems will typically require a fast, low-loss polarization controller that can convert an arbitrary polarization state to a fixed, known polarization state, and if combined with automatic feedback, allow for fast polarization tracking.

Polarization controllers are a common benchtop instrument in communications laboratories. The most common approach to polarization control in the laboratory is an all-fiber manual “paddle” controller. Being all-fiber helps to make these controllers low-loss, but they are implemented in large mechanical systems not fast enough to achieve polarization transitions within a millisecond as needed in the field. An alternative approach that uses thermal gradients in the fiber is likewise too slow. A faster method of polarization control employs fiber squeezers, which are commercially available, to apply a large mechanical stress to a portion of the fiber. The problem with this approach is that large mechanical stress results in a significant reliability hazard. Other alternatives involve coupling the light out of the fiber into discrete optics or alternative waveguide devices, but these approaches suffer loss from the coupling of light into and out of the fiber.

Polarization controllers can also utilize polarization rotation based on the Faraday effect (also known as the magneto-optic effect), that is, the rotation of the polarization direction caused by a magnetic field along the direction of light propagation. When Faraday rotators were first applied to polarization control in optical fiber, the fiber available at the time suffered from high birefringence. The problem of birefringence in optical fiber can be addressed, in principle, by the periodic application of a magnetic field, but at the expense of a greatly reduced wavelength bandwidth. A second problem with polarization control using fiber-optic Faraday rotators is that the rotation per unit length is so small that effective polarization control is, in practice, contingent up a very large interaction length between the magnetic field and the fiber (e.g., tens of meters) or a very large magnetic field. This problem can be mitigated with a toroidal configuration in which the magnetic field is utilized for multiple turns of the optical fiber. This configuration, however, introduces the problem of bend-induced birefringence in the optical fiber, resulting again in very limited bandwidth. Prior attempts to overcome bend-induced birefringence, e.g., by applying lateral stress to cancel it or by alternating the polarity of the magnetic field using two magnets with the fiber coiled into a figure-eight configuration, have had limited success.

### BRIEF DESCRIPTION OF THE DRAWINGS

Described herein are fiber-optic Faraday rotators configured to achieve net-zero bend-induced birefringence. Various embodiments are described with reference to the accompanying drawings, in which:

FIG. 1 conceptually illustrates a Faraday rotator including an optical fiber bent into a series of turns extending along a substantially closed loop and surrounded by a solenoid.

FIG. 2 depicts an example three-dimensional shape of an optical fiber loop.

FIGS. 3A and 3B are graphs showing the power of a polarization-rotated optical signal as a function of wavelength for a circular planar toroid shape and the three-dimensional shape of FIG. 2, respectively.

FIG. 4 is a graph showing the polarization rotation efficiency of a Faraday rotator as a function of the frequency of the drive current and voltage.

### DETAILED DESCRIPTION

This disclosure provides fiber-optic Faraday rotators configured such that any bend-induced birefringence in one portion of the optical fiber is canceled in another portion, enabling substantially net zero bend-induced birefringence along the fiber as a whole. In various embodiments, the optical fiber includes a series of overlapping fiber turns all extending generally along the same path in a substantially closed loop such that the fiber turns at each point of the path effectively form a fiber bundle. The loop is “substantially closed” in the sense that its initial and end points coincide, except for a small displacement between the input and output ends of each fiber turn to allow for connection to the preceding or following turns or input and output sections of the optical fiber. The turns “overlap” and “extend generally along the same path” in the sense that they are spaced close enough together for a single solenoid that is curved with its longitudinal axis along the closed-loop path to surround them jointly (as a bundle). A solenoid, as understood herein, is an electromagnet formed by a helical coil of electrical wire that, upon flow of an electrical current through the wire, creates a magnetic field in the interior of the solenoid along its longitudinal axis. In accordance herewith, the wire is wound helically around the bundle of fiber turns to create a magnetic field in the optical fiber turns along the closed-loop path. In various embodiments, the solenoid extends substantially along the entire closed-loop path.

Light propagating in the optical fiber can generally be thought of as a superposition of left-hand and right-hand circularly polarized components, whose respective field vectors rotate about the direction of propagation in opposite directions. If the field vector of the two components are equal in magnitude, the resulting polarization of the light is linear: otherwise, it is elliptical. The direction of polarization, that is, the electric field vector orientation of linearly polarized light or the orientation of the principle axis of the ellipse that the electric field vector traces for elliptically polarized light, depends on the phase between the two polarization modes. A magnetic field (or field component) along the direction of light propagation causes circular birefringence, that is, a difference in propagation velocity between the two circular polarization modes, which accumulates as a phase retardation of one mode relative to the other, and thus causes a rotation of the direction of polarization. The angle of polarization rotation, θ, is the product of the magnetic flux density B, the length L of interaction of the light with the magnetic field, and an optical material property of the fiber material called the “Verdet constant” V: q=V·B·L. A Faraday rotator exploits this effect to deliberately rotate the polarization by the application of a variable magnetic field.

The direction of polarization can be decomposed in a plane perpendicular to the propagation direction into two projected linear polarization components along mutually orthogonal axes. Bending of an optical fiber generally causes linear birefringence, that is, a difference in propagation velocity between a polarization component along an axis in the plane of the bent (the slow axis) and a polarization component along an axis perpendicular to the plane (the fast axis), causing an accumulation of a phase retardation that generally changes the ellipticity of the polarization and, for initially linearly polarized light accumulating a phase retardation of 180°, the direction of polarization. When light propagates sequentially in two mutually orthogonal planes, the slow and fast axes are switched between the two planes, allowing a bend-induced retardation accumulated during propagation in one plane to be reversed during propagation in the other plane. Taking advantage of this relation, Faraday rotators in accordance with various embodiments are configured to achieve net zero birefringence despite significant fiber bending.

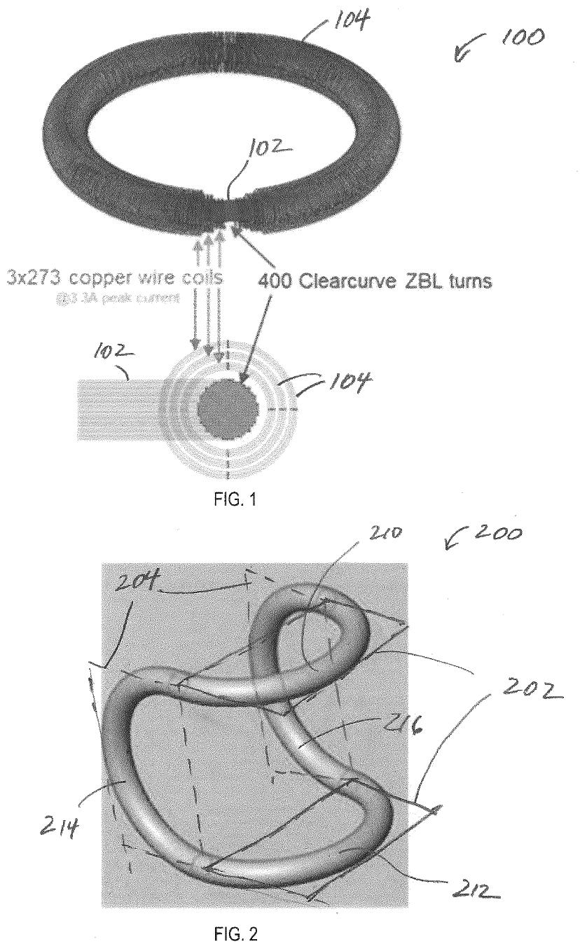

FIG. 1 conceptually illustrates a Faraday rotator 100 including an optical fiber 102 bent into a series of turns extending along a substantially closed loop and surrounded by a solenoid 104. The solenoid serves to create a magnetic field in the optical fiber along the loop upon application of an electrical signal (voltage or current) by a suitable power source (not shown). For simplicity only, the loop is depicted as configured in a single plane, with the fiber 102 and solenoid 104 forming nested tori about an axis of revolution normal to the plane (with a shared toroidal axis lying in the plane). As described below with reference to FIG. 2, the loop of Faraday rotators as disclosed herein instead have a three-dimensional shape, with different sections of the loop lying in different planes for the purpose of compensating for bend-induced infringement, and various aspects illustrated in FIG. 1 can be used in conjunction with such a three-dimensional shape.

The optical fiber 102 is a single, continuous strand of fiber, configured as a coil whose individual turns all generally extend along the same loop (allowing for some vertical displacement from the plane of the loop and radial displacement within the plane to create a toroidal volume that can fit the multiple turns). The use of multiple turns serves to increase the interaction length of an optical signal propagating in the fiber 102 with the magnetic field created inside the solenoid 104: for a loop of circumferential length l, a fiber coil with n turns will have an interaction length L=n·l. By using many turns, even moderate magnetic fields can result in a substantial angle of polarization rotation. In some embodiments, tens or hundreds of fiber turns (e.g., 400 turns) are used. To optimally utilize the magnetic field generated inside the solenoid 104, the Faraday rotator 100 may be configured with the fiber turns spaced densely and collectively taking up a volume that amounts to a large fraction (e.g., the majority) of the interior volume of the solenoid. As shown in the cross-sectional close-up of FIG. 1, the volume occupied by the fiber turns may form a torus, with a circular cross section through the toroid axis. The solenoid 104 may include multiple nested helical wire coils, e.g., three nested coils, to increase the magnetic flux density.

The optical fiber 102 may be standard silica-core or germanium-silicate core fiber. In alternative embodiments, a fiber material that provides a higher Verdet constant than silica or germanium silicate is used, enabling the device to operate at lower drive current. The Verdet constant of the fiber material can be increased using glass compositions that include oxides of heavy metals like lead, bismuth, iron, zinc, or cadmium, or rare-earth elements such as terbium. For example, bismuth cadmium germanium (BCG) glass and bismuth lead germanium borate (BPGB) glass have been shown to achieve Verdet constants of 0.151 arcmin/(Gauss·cm) and 0.162 arcmin/(Gauss-cm), respectively, for 60% mol bismuth concentrations, and bismuth zinc borate (BZB) glass (e.g., of composition (80-x)Bi-₂O₃·xZnO·20B₂O₃) with bismuth concentrations in the range from 50 mol % to 65 mol % have been found to have Verdet constants in the range from 0.666 to 0.799 arcmin/(Gauss-cm).

In various embodiments, the optical fiber 102 has a small radius (in a fiber cross section), e.g., of less than 130 μm, or of less than 50 μm for reduced cladding fiber. A small fiber radius allows for a smaller radius of the fiber turns (i.e., the loop), reducing the size of the Faraday rotator device. In addition, a smaller fiber radius facilitates using a solenoid with a smaller cross section, which reduces the inductance of the solenoid. A smaller inductance, in turn, can help flatten the frequency response of the device. In some embodiments, the trade-off between device compactness and inductance on the one hand and interaction length between light and magnetic field on the other hand is further improved by using a multi-core fiber, with coupling elements that couple light at the end of a fiber turn from one core into another core at the beginning of the fiber turn such that the light traverses the multiple cores sequentially, accumulating polarization rotation along the way.

The increase in interaction length achieved by bending the optical fiber into multiple turns generally comes at the cost of introducing significant bend-induced birefringence, which can interfere with the desired control of the polarization. This problem is addressed, in accordance herewith, by configuring the fiber in a three-dimensional shape in which bend-induced phase retardance incurred in one portion of the fiber is cancelled, in whole or in part, by a bend-induced phase retardance in the opposite direction incurred in another portion of the fiber. More specifically, in various embodiments, the closed loop along which each fiber turn extends is configured to cancel out any bend-induced birefringence over one round-trip.

FIG. 2 depicts an example three-dimensional shape of an optical fiber loop 200 that can achieve substantially net zero bend-induced birefringence, i.e., substantially zero cumulative phase retardation due to bending during one full round trip along the loop. (The modifier “substantially” serves to indicate merely that, in any practical implementation, the cumulative phase retardation may vary slightly from the exact zero value that is achievable theoretically, e.g., due to slight shape variations.) The loop includes four curved sections configured in four respective planes. The four planes include two pairs of parallel planes of mutually orthogonal orientation, e.g., in the depicted orientation, a pair of horizontal planes 202 and a pair of vertical planes 204. A first, disconnected pair 210, 212 of the four curved sections is configured in the pair of horizontal planes 202, and a second, disconnected pair 214, 216 of the four curved sections is configured in the pair of vertical planes 204. The two horizontal sections 210, 212 are connected to each other at respective first ends by one of the vertical sections, 214, and at respective second ends by the other one of the vertical sections, 216. As depicted, at points where loop sections of two orthogonal planes are joined, the loop transitions smoothly from one plane to the other, without kinks, with a tangent to the loop lying in the intersection of the two planes. A kink-free, smooth loop configuration is important for avoiding large scattering losses in the optical fiber.

As light propagates along the loop 200, the linear polarization component that is in the plane of the bend (along the slow axis) in the horizontal planes 202 will be perpendicular to the plane of the bend (along the fast axis) in the vertical planes 204 and vice versa. Accordingly, by configuring the loop sections 210, 212, 214, 216 (e.g., in shape and length) such that the phase retardation accumulated by the in-plane polarization component relative to the out-of-plane polarization component is the same in each of the horizontal and vertical planes 202, 204, the amount of birefringence incurred in the horizontal planes 202 is canceled by a negative amount of birefringence of equal magnitude incurred in the vertical planes 204, provided that the radius of all bends is made sufficiently large that the cumulative phase retardance at any point along the loop is less than x to ensure that the polarization rotations between the axes always add constructively. One way of achieving equal, but opposite phase retardations in the horizontal and vertical planes is to use the same shape and size, e.g., a semicircle of substantially the same radius of curvature, for all four of the loop sections 210, 212, 214, 216. Note that this is not the only possible configuration: for instance, the sections in the vertical planes could instead have sharper bends of smaller arc length than the horizontal sections. The optical fiber can be configured in the depicted shape by winding the fiber around two mandrels: a vertically oriented cylinder (or half-cylinder) around which the horizontal sections are wound and a horizontally oriented cylinder (or half-cylinder) around which the vertical sections are wound. Note that, although practical implementations of Faraday rotators will generally include multiple fiber turns to achieve substantial polarization rotation without the need for extremely large magnetic fields, a Faraday rotator having only a single fiber turn along the loop 200 is also possible at least in principle, and will equally benefit from the net zero bend-induced birefringence achieved by the shape of the loop 200.

The requirement that a half-turn of the fiber (corresponding to one of the four sections) induces birefringence resulting in less than a x phase shift of the fast relative to the slow orientation of the orthogonal polarization components imposes the following condition for the lower limit on the bend radius R:

$$R > \frac{π \cdot C \cdot E \cdot {a}^{2}}{λ} ,$$

wherein C is the stress-optical coefficient, E is Young's modulus, a is the radius of the fiber, and λ is the center wavelength of operation. Additionally, if there is error in the size of the fiber bends in the two planes, the accumulating error should be kept to a minimum to avoid continuous increase in the phase error. This condition implies:

$$\frac{Δ R}{R} \leq \frac{1}{\frac{N \cdot α}{R} - 1} and \\ α = \frac{π \cdot C \cdot E \cdot {a}^{2}}{λ} ,$$

wherein N is the number of fiber turns and AR is the error in the size of the two mandrels. A more stringent condition is that the phase shift is maintained positive throughout the loops, which is true if

$$\frac{Δ R}{R} \leq \frac{1}{\frac{N \cdot α}{R ( 1 - \frac{α}{R} )} - 1} .$$

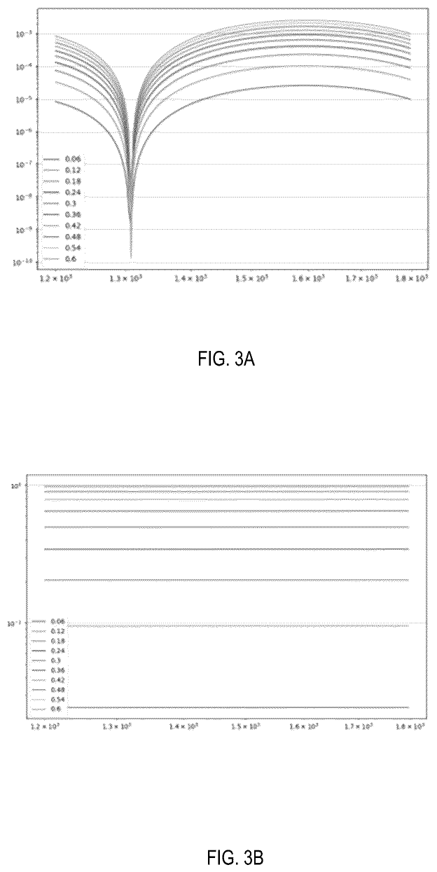

FIGS. 3A and 3B depict graphs of the simulated power of a polarization-rotated optical signal as a function of wavelength for a circular planar toroid shape as shown in FIG. 1 and the three-dimensional shape of FIG. 2, respectively, illustrating the benefit of the latter. The simulations were performed for silica fiber with a 40-μm cladding radius, including 300 fiber turns bent into a loop with a radius of 10 cm, surrounded by a solenoid having 3000 wire turns and driven by currents ranging from 0.06 A to 0.6 A. For FIG. 3B, to simulate construction error in the horizontal and vertical sections of the three-dimensional loop, a 1% systematic error in the bend radius of the two planes was included in the simulation. FIG. 3A shows that, for the planar toroid, the rotated power varies drastically with the wavelength of the light, approaching zero near a wavelength of 1.3 μm, and the peak rotated power is limited by the bend-induced birefringence of the fiber loop. FIG. 3B shows that, for the three-dimensional loop shape of FIG. 2, the rotate power is nearly wavelength-independent over a range from 1200 μm to about 1800 μm, and approaches 100% even with the simulated 1% error in bend radius. Faraday rotators using this loop shape, thus, can achieve high rotation efficiency and a large optical bandwidth.

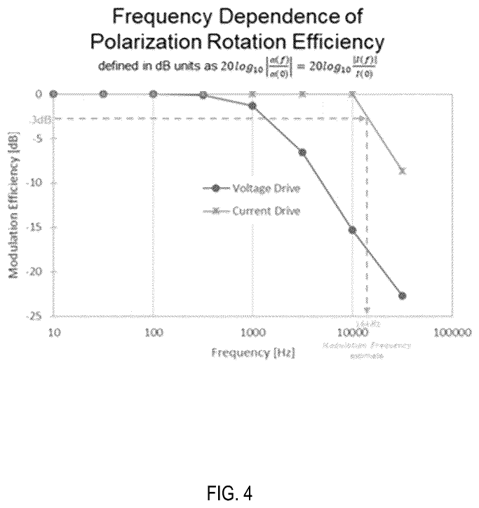

Faraday rotators as described herein may be employed in the field to compensate for random polarization fluctuations across a wide range of frequencies. In such applications, it is desirable that the efficiency of polarization rotation is fairly uniform across frequency. FIG. 4 is a graph showing the polarization rotation efficiency of a Faraday rotator as described herein (e.g., Faraday rotator 100 as modified according to the loop shape 200) for both current and voltage control of the solenoid as a function of the frequency of the drive current or drive voltage, respectively, as determined by finite element modeling. As can be seen, current control theoretically provides polarization rotation for 100% of the light over a larger range than voltage control, up to more than 10 kHz, with rotation efficiency declining to −3 dB at around 16 kHz. Accordingly, fixed drive current is preferred in various embodiments.

Faraday rotators as described above can be activated and controlled electrically, and allow for configurations that are compact and efficient due to the use of many overlapping fiber loops within the same magnetic field while also providing large optical bandwidth as a result of the net cancelation of bend-induced birefringence. Such rotator devices can be employed in optical isolators, polarization-based optical switches, and polarization controllers suited, e.g., for quantum communications.

A polarization controller providing full control of the polarization on the Poincare sphere may be made from two Faraday rotator devices as described above in conjunction with a birefringent phase shift device, placed between the two Faraday rotator devices, that imparts a phase shift between two orthogonal polarization components. Suitable phase shift devices are known to those of ordinary skill in the art. The phase shift device may be, for instance, be a quarter wave plate, which imparts a 90° relative phase delay (corresponding to a quarter of the wavelength) between two orthogonal linear polarizations. In some embodiments, such a quarter wave plate is implemented by a section of polarization-maintaining (PM) optical fiber having a length that results in the desired 90° relative phase delay.

A polarization-based optical 1×2 switch (e.g., a switch having an input and two outputs) may be formed of a Faraday rotator device as described above, operated by an associated electronic controller, in conjunction a polarization-sensitive coupler whose input is coupled to the output of the Faraday rotator device. The controller is configured to switch the electrical current through the solenoid of the Faraday rotator between two values that result, for an optical signal with a given polarization direction at the input of the Faraday rotator device (corresponding to the input of the switch), in two respective polarization directions at the output of the Faraday rotator device. The polarization-sensitive coupler couples the optical signal received from the Faraday rotator device to one of two outputs (constituting the outputs of the switch) depending on the direction of polarization of the optical signal. Suitable polarization-sensitive couplers are known to those of ordinary skill in the art.

While the invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is provisionally claimed is:

1. A Faraday rotation device comprising:
an optical fiber comprising a series of fiber turns all extending along a common path in a substantially closed loop, the loop having a three-dimensional shape comprising a first pair of curved sections configured in a first pair of parallel planes and a second pair of curved sections configured in a second pair of parallel planes, the curved sections of the first pair being connected to each other by the curved sections of the second pair, the first pair of parallel planes being perpendicular to the second pair of parallel planes; and
a solenoid comprising an electrical wire wound helically around the one or more turns of the optical fiber along the loop to generate a magnetic field in the optical fiber along the loop that causes a rotation of a direction of polarization of an optical signal propagating in the optical fiber.

2. The device of claim 1, wherein the first pair of curved sections is configured to cause bend-induced birefringence of the optical signal by a first amount and the second pair of curved sections is configured to cause bend-induced birefringence of the optical signal by a negative of the first amount to result in substantially net zero birefringence over a round-trip along the loop.

3. The device of claim 1, wherein a radius of curvature along the first pair of curved sections is substantially equal to a radius of curvature along the second pair of curved sections, and wherein a size of the first pair of curved sections is substantially equal to a size of the second pair of curved sections.

4. The device of claim 1, wherein a radius of curvature along the fiber loop is sufficiently large that a cumulative phase retardance between perpendicular directions of polarization is less than x at any point along the loop.

5. The device of claim 1, wherein the fiber comprises a core made of one of silica or germanium-silicate.

6. The device of claim 1, wherein the fiber comprises a core comprising at least one heavy-metal oxide.

7. The device of claim 6, wherein the at least one heavy-metal oxide comprises an oxide of at least one of lead, bismuth, cadmium, iron, or zinc.

8. The device of claim 6, wherein the core of the fiber comprises at least one of bismuth cadmium germanium (BCG), bismuth lead germanium borate (BPGB), or bismuth zinc borate (BZB).

9. The device of claim 1, wherein the fiber comprises a core comprising at least one rare-earth metal.

10. The device of claim 1, wherein the optical fiber is made of material having a Verdet constant of at least 0.2 arcmin per Gauss per centimeter.

11. The device of claim 1, wherein a radius of a cross section of the optical fiber is less than 130 μm.

12. The device of claim 11, wherein the optical fiber is a reduced cladding optical fiber having a radius of less than 50 μm.

13. The device of claim 1, wherein the optical fiber comprises first and second optical cores, an output of the first optical core being coupled to an input of the second optical core.

14. The device of claim 1, wherein a rotated power of an optical signal propagating through the loop is wavelength-independent across a range from about 1200 μm to about 1800 μm.

15. The device of claim 1, further comprising a power source to apply an electrical signal to the solenoid to thereby generate the magnetic field.

16. The device of claim 15, wherein the electrical signal is a constant current.

17. A polarization controller comprising:
two Faraday rotation devices each comprising:
an optical fiber comprising a series of fiber turns all extending along a common path in a substantially closed loop, the loop having a three-dimensional shape comprising a first pair of curved sections configured in a first pair of parallel planes and a second pair of curved sections configured in a second pair of parallel planes, the curved sections of the first pair being connected to each other by the curved sections of the second pair, the first pair of parallel planes being perpendicular to the second pair of parallel planes; and
a solenoid comprising an electrical wire wound helically around the one or more turns of the optical fiber along the loop to generate a magnetic field in the optical fiber along the loop that causes a rotation of a direction of polarization of an optical signal propagating in the optical fiber; and
a phase shift device coupled between the two Faraday rotation devices along a photonic path.

18. The polarization controller of claim 17, wherein the phase shift device comprises a section of polarization-maintaining fiber having a length selected to impart a quarter-wavelength phase shift at a specified operating wavelength.

19. The polarization controller of claim 17, wherein the phase shift device comprises a quarter wave plate.

20. The polarization controller of claim 17, wherein, in each of the two Faraday rotation devices, the first pair of curved sections is configured to cause bend-induced birefringence of the optical signal by a first amount and the second pair of curved sections is configured to cause bend-induced birefringence of the optical signal by a negative of the first amount to result in substantially net zero birefringence over a round-trip along the loop.

21. An optical switch having an input and two outputs, the optical switch comprising:
a Faraday rotation device comprising:
coupled to the input, an optical fiber comprising a series of fiber turns all extending along a common path in a substantially closed loop, the loop having a three-dimensional shape comprising a first pair of curved sections configured in a first pair of parallel planes and a second pair of curved sections configured in a second pair of parallel planes, the curved sections of the first pair being connected to each other by the curved sections of the second pair, the first pair of parallel planes being perpendicular to the second pair of parallel planes; and
a solenoid comprising an electrical wire wound helically around the one or more turns of the optical fiber along the loop to generate a magnetic field in the optical fiber along the loop that causes a rotation of a direction of polarization of an optical signal propagating in the optical fiber;
optically coupled to an output of the Faraday rotation device, a polarization-sensitive coupler configured to couple the optical signal selectively to one of the two outputs depending on the direction of polarization of the optical signal; and
a controller configured to switch an electrical current through the electrical wire between a first value that results in first direction of polarization of the optical signal at the output of the Faraday rotation device and a second value that results in a second direction of polarization of the optical signal at the output of the Faraday rotation device to thereby switch the optical signal between the two outputs.
